(19) United States
(12) Patent Application Publication
(10) Pub. No.: US 2013/0120964 A1
(43) Pub. Date: May 16, 2013

(54) ALUMINATE PHOSPHORS

(71) Applicants: Tim Vosgroene, Ober-Ramstadt (DE); Holger Winkler, Darmstadt (DE); Ralf Petry, Griesheim (DE)

(72) Inventors: Tim Vosgroene, Ober-Ramstadt (DE); Holger Winkler, Darmstadt (DE); Ralf Petry, Griesheim (DE)

(73) Assignee: MERCK PATENT GMBH, Darmstadt (DE)

(21) Appl. No.: 13/810,737

(22) PCT Filed: Jun. 24, 2011
(86) PCT No.: PCT/EP2011/003132

§ 371 Date: Jan. 17, 2013

(30) Foreign Application Priority Data
Jul. 21, 2010 (DE) 10 2010 031 755.1

(51) Int. Cl. C09K 11/77; F21V 9/16

(52) U.S. Cl. CPC C09K 11/7774; F21V 9/16
USPC 362/84; 252/301.4 F

(57) ABSTRACT

The invention relates to compounds of the general formula (I) SrLu₂₋ₓSiAl₄O₁₂:Ceₓ (I) where x stands for a value from the range from 0.01 to 0.1 and a process for the preparation of these phosphors, and the use thereof as conversion phosphors or in lamps.

The invention relates to aluminate compounds, processes for the preparation of these compounds, and the use thereof as conversion phosphors or in lamps.

LEDs are increasing in importance—both as lighting means and also on use as backlighting in liquid-crystal displays (LC displays). These novel light sources have a number of advantages compared with conventional cold cathode fluorescent lamps (CCFLs), such as a longer lifetime, a potential saving in energy, the absence of harmful contents (such as mercury in CCFLs).

High demands are made of the phosphors in LEDs, which must have high and temperature-constant efficiency and must be chemically stable. Phosphors having the composition MLn₂QR₄O₂, where M stands for at least one of the elements Mg, Ca, Sr or Ba, Ln stands for at least one of the elements Sc, Y, La, Ce, Pr, Nd, Sm, Eu, Gd, Tb, Dy, Ho, Er, Tm, Yb and Lu; Q stands for one of the elements Si, Ge, Sn, and Pb, and finally R stands for at least one of the elements B, Al, Ga, In and TI, are known from US 2004/0062699, for example BaY_{1.98}Ce_{0.02}SiAl₄O₁₂, SrY_{1.98}Ce_{0.02}SiAl₄O₁₂ and BaLu_{1.98}Ce_{0.02}SiAl₄O₁₂.

The object of the present invention was to develop aluminate phosphors which have higher light efficiency than known systems.

Surprisingly, it has now been found that an SrLu₂ aluminate phosphor has higher light efficiency than the phosphors mentioned above and in addition also has higher temperature stability (TQ₅₀).

A first embodiment of the present invention is therefore a compound of the formula I,

SrLu₂₋ₓSiAl₄O₁₂:Ceₓ (I)

where
x stands for a value from the range from 0.01 to 0.15.

x preferably stands for a value from the range 0.015 to 0.12 and particularly preferably from the range 0.016 to 0.10.

Phosphors according to the invention give rise to good LED qualities even when employed in small amounts. The LED quality is described here via conventional parameters, such as, for example, the colour rendering index, the TQ₅₀ value and the colour point in CIE x and CIE y coordinates.

The colour rendering index or CRI is a dimensionless lighting quantity, familiar to the person skilled in the art, which compares the colour reproduction faithfulness of an artificial light source with that of sunlight and/or filament light sources (the latter two have a CRI of 100).

The TQ₅₀ value is the temperature at which the emission spectrum of a phosphor or LED still has 50% of the intensity that it had at a temperature of 0° C.

CIE x and CIE y stand for the coordinates in the standard CIE colour chart (here standard observer 1931), familiar to the person skilled in the art, by means of which the colour of a light source is described.

All the quantities mentioned above are calculated from emission spectra of the light source by methods familiar to the person skilled in the art.

In the context of this application, green emission or green light denotes light whose intensity maximum is at a wavelength between 508 nm and 550 nm; correspondingly, yellow denotes light whose maximum is at a wavelength between 551 nm and 585 nm, and red denotes light whose maximum is at a wavelength between 610 nm and 670 nm.

The invention furthermore relates to a process for the preparation of a compound of the formula I.

To this end, in a step a), lutetium-, cerium-, aluminium-, strontium- and silicon-containing materials are mixed, and, in step b), at least one further inorganic or organic substance is also added to the mixture, and then, in a step c), the mixture is subjected to thermal aftertreatment, preferably under reductive conditions.

The above-mentioned thermal treatment is preferably carried out at least partly under reducing conditions. In step b), the reaction is usually carried out at a temperature above 900° C., preferably at a temperature above 1000° C. and particularly preferably in the range 1100° C.-1500° C. The reductive conditions here are established, for example, using carbon monoxide, forming gas or hydrogen or at least vacuum or an oxygen-deficient atmosphere, preferably in a stream of argon, preferably in a stream of Ar/H₂ and particularly preferably in a stream of Ar/H₂ (90-70:10-30). In addition, the thermal aftertreatment can be carried out in one or more steps, with the multistep procedure, in particular the two-step procedure, being preferred.

The inorganic or organic substance employed (in step b) is a substance from the group of the ammonium halides, preferably ammonium chloride, alkaline-earth metal fluorides, such as calcium fluoride, strontium fluoride or barium fluoride, borates, boric acid, carbonates, preferably ammonium hydrogencarbonate, alcoholates, such as oxalates, and/or silicic acid, such as tetraethyl orthosilicate (TEOS).

The phosphors according to the invention can be prepared either by wet-chemical methods or by the solid-state diffusion method (mixing and firing), where the wet-chemical methods from inorganic and/or organic metal and/or rare-earth salts by means of sol-gel methods, coprecipitation methods and/or drying methods, preferably spray drying, are preferred.

Wet-chemical preparation generally has the advantage over the conventional solid-state diffusion method that the resultant materials have greater uniformity with respect to the stoichiometric composition, the particle size and the morphology of the particles from which the phosphor according to the invention is prepared.

The following known methods are preferred for wet-chemical pretreatment of an aqueous precursor of the phosphors (phosphor precursors) consisting, for example, of a mixture of lutetium chloride, cerium chloride, aluminium chloride, strontium chloride, tetraethyl orthosilicate and ammonium hydrogencarbonate solution:
Coprecipitation using an NH₄HCO₃ solution (see, for example, Jander, Blasius Lehrbuch der analyt. u. präp. anorg. Chem. 2002 [Blasius's Textbook of Analyt. and Prep. Inorg, Chem 2002])
Pecchini process using a solution of citric acid and ethylene glycol (see, for example, Annual Review of Materials Research Vol. 36: 2006, 281-331)
Combustion process using urea
Spray drying of aqueous or organic salt solutions (starting materials)
Spray pyrolysis of aqueous or organic salt solutions (starting materials)
Evaporation of nitrate solutions and thermal conversion of the residue

In the above-mentioned coprecipitation, a TEOS/NH₄HCO₃ solution is added to, for example, chloride solutions of the corresponding phosphor starting materials, resulting in the formation of the phosphor precursor, which is subsequently converted into the phosphor by one- or multistep thermal treatment. This method is particularly preferred in accordance with the invention.

In the Pecchini process, a precipitation reagent consisting of citric acid and ethylene glycol is added to, for example, nitrate solutions of the corresponding phosphor starting materials at room temperature, and the mixture is subsequently heated. The increase in viscosity results in the formation of the phosphor precursor.

In the known combustion process, nitrate solutions, for example, of the corresponding phosphor starting materials are dissolved in water, the solution is then refluxed, and urea is added, resulting in the slow formation of the phosphor precursor.

Spray pyrolysis is one of the aerosol processes, which are characterised by spraying of solutions, suspensions or dispersions into a reaction space (reactor) heated in various ways and the formation and deposition of solid particles. In contrast to spray drying at hot-gas temperatures <200° C., spray pyrolysis, as a high-temperature process, involves thermal decomposition of the starting materials used (for example salts) and the re-formation of substances (for example oxides or mixed oxides) in addition to evaporation of the solvent.

The 6 process variants mentioned above are described in detail in WO 2007/144060 (Merck), which is incorporated in its full scope into the context of the present application by way of reference.

The green-emitting phosphors according to the invention can be mixed with red-emitting phosphors, making such mixtures highly suitable for applications in general lighting and LCD backlighting.

A further embodiment of the present invention is therefore a mixture comprising at least one compound of the formula I and at least one red-emitting phosphor, where the latter is preferably selected from Ce-doped garnets, Eu-doped thiogallates, Eu-doped sulfoselenides and Eu- and/or Ce-doped nitrides, oxynitrides, alumonitrides and/or Mn(IV)-doped oxides and/or fluorides. It may be particularly preferred for the red-emitting phosphor to be selected from the nitridic phosphors, preferably (Ca,Sr,Ba)₂Si₅N₈:Eu, (Ca,Sr)AlSiN₃:Eu, (Ca,Sr,Ba)SiN₂:Eu, (Ca,Sr,Ba)₆Si₃O₆N₄:Eu, A_{2-0.5y-x} Euₓ Si₅N_{8-y} O_{y}, where A stands for one or more elements selected from Ca, Sr, Ba, and x stands for a value from the range from 0.005 to 1 and y stands for a value from the range from 0.01 to 3, or variants of the said compounds in which individual lattice positions are substituted by other chemical elements, such as alkali metals, aluminium, gallium or gadolinium, or further elements of this type occupy flaws as dopant. Material systems which are known to the person skilled in the art and are suitable are siliconitrides and alumosiliconitrides (cf. Xie, Sci. Technol. Adv. Mater. 2007, 8, 588-600): 1-1-2-nitrides, such as, for example, CaSiN₂:Eu²⁺ (Le Toquin, Cheetham, Chem. Phys. Lett. 2006, 423, 352), 2-5-8-nitrides, such as (Ca,Sr,Ba)₂Si₅N₈:Eu²⁺ (Li et al., Chem. Mater. 2005, 15, 4492), and alumosiliconitrides, such as (Ca,Sr)AlSiN₃:Eu²⁺ (K. Uheda et al., Electrochem. Solid State Lett. 2006, 9, H22).

The compound A_{2-0.5y-x} Euₓ Si₅N_{8-y}O_{y}, where A stands for one or more elements selected from Ca, Sr, Ba, and x stands for a value from the range from 0.005 to 1 and y stands for a value from the range from 0.01 to 3, is described in patent application EP10000933.1 and is called compound of the formula II below. The compound can be present here as a pure substance or in a mixture with at least one further silicon- and oxygen-containing compound, it being preferred for the at least one further silicon- and oxygen-containing compound to be a reaction by-product of the preparation of the compound of the formula II and for this not to adversely affect the application-relevant optical properties of the compound of the formula II. The invention therefore furthermore relates to a mixture comprising a compound of the formula II, which mixture is obtainable by a process in which, in a step a), suitable starting materials selected from binary nitrides, halides and oxides or corresponding reactive forms thereof are mixed, and, in a step b), the mixture is thermally treated under reductive conditions.

In the compounds of the formula II according to the invention, A in preferred embodiments stands for Sr, while x in preferred embodiments stands for a value from the range from 0.01 to 0.8, preferably from the range 0.02 to 0.7 and particularly preferably from the range 0.05 to 0.6 and particularly preferably from the range 0.1 to 0.4, and y in preferred embodiments stands for a value from the range from 0.1 to 2.5, preferably from the range 0.2 to 2 and particularly preferably from the range 0.22 to 1.8.

For the preparation of phosphors of the formula II, suitable starting materials selected from binary nitrides, halides and oxides or corresponding reactive forms thereof are mixed in a step a), and the mixture is thermally treated under reductive conditions in a step b). In the above-mentioned thermal treatment, it is preferred for this to be carried out at least partly under reducing conditions. In step b), the reaction is usually carried out at a temperature above 800 C, preferably at a temperature above 1200° C. and particularly preferably in the range 1400° C.-1800° C. The reductive conditions here are established, for example, using carbon monoxide, forming gas or hydrogen or at least vacuum or an oxygen-deficient atmosphere, preferably in a nitrogen stream, preferably in an N2/H2 stream and particularly preferably in an N2/H2/NH3 stream. If it is intended to prepare the compounds of the formula II in pure form, this can be carried out either via precise control of the starting-material stoichiometry or by mechanical separation of the crystals of the compounds of the formula II from the glass-like fractions. The separation can be carried out, for example, via the different density, particle shape or particle size by separation methods known to the person skilled in the art.

In accordance with the invention, the compound (or phosphor) of the formula I and the at least one red-emitting phosphor are usually present here in the weight ratio 20:1 to 1:1. It is preferred in accordance with the invention for the at least one phosphor of the formula I and the at least one red-emitting phosphor to be present in the weight ratio 10:1 to 3:1 and particularly preferably 6:1 to 4:1.

The invention furthermore relates to a process for the preparation of a phosphor mixture in which at least one compound (or phosphor) of the formula I is mixed with at least one red-emitting phosphor.

The particle size of the phosphors according to the invention is usually between 50 nm and 30 μm, preferably between 1 μm and 20 μm.

In a further preferred embodiment, the phosphors in particle form have a continuous surface coating consisting of SiO₂, TiO₂, Al₂O₃, ZnO, ZrO₂ and/or Y₂O₃ or mixed oxides thereof. This surface coating has the advantage that, through a suitable grading of the refractive indices of the coating materials, the refractive index can be matched to the environment. In this case, the scattering of light at the surface of the phosphor is reduced and a greater proportion of the light can penetrate into the phosphor and be absorbed and converted therein. In addition, the refractive index-matched surface coating enables more light to be coupled out of the phosphor since total internal reflection is reduced.

In addition, a continuous layer is advantageous if the phosphor has to be encapsulated. This may be necessary in order to counter sensitivity of the phosphor or parts thereof to diffusing water or other materials in the immediate environment. A further reason for encapsulation with a closed shell is thermal decoupling of the actual phosphor from the heat generated in the chip. This heat results in a reduction in the fluorescence light yield of the phosphor and may also influence the colour of the fluorescence light.

Finally, a coating of this type enables the efficiency of the phosphor to be increased by preventing lattice vibrations arising in the phosphor from propagating to the environment.

In addition, it is preferred for the phosphors to have a porous surface coating consisting of SiO₂, TiO₂, Al₂O₃, ZnO, ZrO₂ and/or Y₂O₃ or mixed oxides thereof or of the phosphor composition. These porous coatings offer the possibility of further reducing the refractive index of a single layer. Porous coatings of this type can be produced by three conventional methods, as described in WO 03/027015, which is incorporated in its full scope into the context of the present application by way of reference: the etching of glass (for example soda-lime glasses (see U.S. Pat. No. 4,019,884)), the application of a porous layer, and the combination of a porous layer and an etching operation.

In a further preferred embodiment, the phosphor particles have a surface which carries functional groups which facilitate chemical bonding to the environment, preferably consisting of epoxy or silicone resin. These functional groups can be, for example, esters or other derivatives which are bonded via oxo groups and are able to form links to constituents of the binders based on epoxides and/or silicones. Surfaces of this type have the advantage that homogeneous incorporation of the phosphors into the binder is facilitated. Furthermore, the rheological properties of the phosphor/binder system and also the pot lives can thereby be adjusted to a certain extent. Processing of the mixtures is thus simplified.

Since the phosphor layer according to the invention applied to the LED chip preferably consists of a mixture of silicone and homogeneous phosphor particles which is applied by bulk casting, and the silicone has a surface tension, this phosphor layer is not uniform at a microscopic level or the thickness of the layer is not constant throughout. This is generally also the case if the phosphor is not applied by the bulk-casting process, but instead in the so-called chip-level conversion process, in which a highly concentrated, thin phosphor layer is applied directly to the surface of the chip with the aid of electrostatic methods.

With the aid of the above-mentioned process, it is possible to produce any desired outer shapes of the phosphor particles, such as spherical particles, flakes and structured materials and ceramics.

The preparation of flake-form phosphors as a further preferred embodiment is carried out by conventional processes from the corresponding metal and/or rare-earth salts. The preparation process is described in detail in EP 763573 and DE 102006054331, which are incorporated in their full scope into the context of the present application by way of reference. These flake-form phosphors can be prepared by coating a natural or synthetically prepared, highly stable support or a substrate comprising, for example, mica, SiO₂, Al₂O₃, ZrO₂, glass or TiO₂ flakes which has a very large aspect ratio, an atomically smooth surface and an adjustable thickness with a phosphor layer by a precipitation reaction in aqueous dispersion or suspension. Besides mica, ZrO₂, SiO₂, Al₂O₃, glass or TiO₂ or mixtures thereof, the flakes may also consist of the phosphor material itself or be built up from one material. If the flake itself merely serves as support for the phosphor coating, the latter must consist of a material which is trans-parent to the primary radiation of the LED, or absorbs the primary radiation and transfers this energy to the phosphor layer. The flake-form phosphors are dispersed in a resin (for example silicone or epoxy resin), and this dispersion is applied to the LED chip.

The flake-form phosphors can be prepared on a large industrial scale in thicknesses of 50 nm to about 20 μm, preferably between 150 nm and 5 μm. The diameter here is 50 nm to 20 μm.

It generally has an aspect ratio (ratio of the diameter to the particle thickness) of 1:1 to 400:1 and in particular 3:1 to 100:1.

The flake dimensions (length×width) are dependent on the arrangement. Flakes are also suitable as centres of scattering within the conversion layer, in particular if they have particularly small dimensions.

The surface of the flake-form phosphor according to the invention facing the LED chip can be provided with a coating which has an antireflection action with respect to the primary radiation emitted by the LED chip. This results in a reduction in back-scattering of the primary radiation, enabling the latter to be coupled better into the phosphor body according to the invention.

Suitable for this purpose are, for example, coatings of matched refractive index, which must have a following thickness d: d=[wavelength of the primary radiation of the LED chip/(4*refractive index of the phosphor ceramic)], see, for example, Gerthsen, Physik [Physics], Springer Verlag, 18th Edition, 1995. This coating may also consist of photonic crystals, which also includes structuring of the surface of the flake-form phosphor in order to achieve certain functionalities.

The production of the phosphors according to the invention in the form of ceramic bodies is carried out analogously to the process described in DE 102006037730 (Merck), which is incorporated in its full scope into the context of the present application by way of reference. In this process, the phosphor is prepared by wet-chemical methods by mixing the corresponding starting materials and dopants, subsequently subjected to isostatic pressing and applied directly to the surface of the chip in the form of a homogeneous, thin and non-porous flake. There is thus no location-dependent variation of the excitation and emission of the phosphor, which means that the LED provided therewith emits a homogeneous light cone of constant colour and has high light output. The ceramic phosphor bodies can be produced on a large industrial scale, for example, as flakes in thicknesses of a few 100 nm to about 500 μm. The flake dimensions (length×width) are dependent on the arrangement. In the case of direct application to the chip, the size of the flake should be selected in accordance with the chip dimensions (from about 100 μm*100 μm to several mm²) with a certain oversize of about 10% to 30% of the chip surface with a suitable chip arrangement (for example flip-chip arrangement) or correspondingly. If the phosphor flake is installed over a finished LED, all of the exiting light cone passes through the flake.

The side surfaces of the ceramic phosphor body can be coated with a light metal or noble metal, preferably aluminium or silver. The metal coating has the effect that light does not exit laterally from the phosphor body. Light exiting laterally can reduce the luminous flux to be coupled out of the LED. The metal coating of the ceramic phosphor body is carried out in a process step after the isostatic pressing to give rods or flakes, where the rods or flakes can optionally be cut to the requisite size before the metal coating. To this end, the side surfaces are wetted, for example, with a solution comprising silver nitrate and glucose and subsequently exposed to an ammonia atmosphere at elevated temperature. A silver coating, for example, forms on the side surfaces in the process.

Alternatively, currentless metallisation processes are also suitable, see, for example, Hollemann-Wiberg, Lehrbuch der Anorganischen Chemie [Textbook of Inorganic Chemistry], Walter de Gruyter Verlag or Ullmanns Enzyklopädie der chemischen Technologie [Ullmann's Encyclopaedia of Chemical Technology].

The ceramic phosphor body can, if necessary, be fixed to the baseboard of an LED chip using a water-glass solution.

In a further embodiment, the ceramic phosphor body has a structured (for example pyramidal) surface on the side opposite an LED chip. This enables as much light as possible to be coupled out of the phosphor body. The structured surface on the phosphor body is produced by carrying out the isostatic pressing using a compression mould having a structured pressure plate and thus embossing a structure into the surface. Structured surfaces are desired if the aim is to produce the thinnest possible phosphor bodies or flakes. The pressing conditions are known to the person skilled in the art (see J. Kriegsmann, Technische keramische Werkstoffe [Industrial Ceramic Materials], Chapter 4, Deutscher Wirtschaftsdienst, 1998). It is important that the pressing temperatures used are ⅔ to ⅚ of the melting point of the substance to be pressed.

In addition, the phosphors according to the invention can be excited over a broad range, extending from about 410 nm to 530 nm, preferably 430 nm to about 500 nm. These phosphors are thus not only suitable for excitation by UV- or blue-emitting light sources, such as LEDs or conventional discharge lamps (for example based on Hg), but also for light sources such as those which utilise the blue In³⁺ line at 451 nm.

The present invention furthermore relates to a light source, characterised in that it comprises a semiconductor and at least one phosphor of the formula I and at least one red-emitting phosphor. This lighting unit is preferably white-emitting or emits light having a certain colour point (colour-on-demand principle).

The present invention furthermore relates to a light source, characterised in that it comprises a semiconductor and at least one phosphor of the formula I.

The colour-on-demand concept is taken to mean the production of light having a certain colour point using a pcLED (=phosphor-converted LED) using one or more phosphors. This concept is used, for example, in order to produce certain corporate designs, for example for illuminated company logos, trademarks, etc.

In a preferred embodiment of the light source according to the invention, the semiconductor is a luminescent indium aluminium gallium nitride, in particular of the formula

InᵢGaᵢAlₖN, where 0≦i, ≦0≦j, 0≦k, and i+j+k=1.

In a further preferred embodiment of the light source according to the invention, the light source is a luminescent arrangement based on ZnO, TCO (transparent conducting oxide), ZnSe or SiC or an arrangement based on an organic light-emitting layer (OLED).

In a further preferred embodiment of the light source according to the invention, the light source is a source which exhibits electroluminescence and/or photoluminescence. The light source may furthermore also be a plasma or discharge source.

Possible forms of light sources of this type are known to the person skilled in the art. These can be light-emitting LED chips of various structure.

The phosphors according to the invention can either be dispersed in a resin (for example epoxy or silicone resin) or, in the case of suitable size ratios, arranged directly on the light source or alternatively arranged remote therefrom, depending on the application (the latter arrangement also includes “remote phosphor technology”). The advantages of remote phosphor technology are known to the person skilled in the art and are revealed, for example, by the following publication: Japanese Journ. of Appl. Phys. Vol. 44, No. 21 (2005). L649-L651.

The invention furthermore relates to a lighting unit, in particular for the backlighting of display devices, which is characterised in that it comprises at least one light source described above, and to corresponding display devices, in particular liquid-crystal display devices (LC displays), having backlighting, which are characterised in that they comprise at least one lighting unit of this type.

Preference is furthermore given to a lighting unit, in particular for general lighting, which is characterised in that it has a CRI (=colour rendering index)>60, preferably >70, more preferably >80. However, CRI values >80 can only be achieved if the green phosphor according to the invention is additionally combined with red phosphors in the LED.

In a further embodiment, it is preferred for the optical coupling of the lighting unit between the phosphor and the light source to be achieved by a light-conducting arrangement.

This makes it possible for the light source to be installed at a central location and to be optically coupled to the phosphor by means of light-conducting devices, such as, for example, optical fibres. In this way, it is possible to achieve lamps adapted to the lighting wishes which merely consist of one or various phosphors, which can be arranged to form a light screen, and an optical waveguide, which is coupled to the light source. In this way, it is possible to place a strong light source at a location which is favourable for electrical installation and to install lamps comprising phosphors which are coupled to the optical waveguides at any desired locations without further electrical cabling, but instead only by laying optical waveguides.

The present invention furthermore relates to the use of the phosphors according to the invention for the partial or complete conversion of the blue or near-UV emission from a luminescent diode.

Preference is furthermore given to the use of the phosphors according to the invention for the conversion of the blue or near-UV emission into visible white radiation. Preference is furthermore given to the use of the phosphors according to the invention for the conversion of the primary radiation into a certain colour point in accordance with the “colour-on-demand” concept.

The present invention furthermore relates to the use of the phosphors according to the invention in electroluminescent materials, such as, for example, electroluminescent films (also known as lighting films or light films), in which, for example, zinc sulfide or zinc sulfide doped with Mn²⁺, Cu⁺ or Ag⁺ is employed as emitter, which emit in the yellow-green region. The areas of application of the electroluminescent film are, for example, advertising, display backlighting in liquid-crystal display screens (LC displays) and thin-film transistor (TFT) displays, self-illuminating vehicle license plates, floor graphics (in combination with a crush-resistant and slip-proof laminate), in display and/or control elements, for example in automobiles, trains, ships and aircraft, or also domestic appliances, garden equipment, measuring instruments or sport and leisure equipment.

The following examples are intended to illustrate the present invention. However, they should in no way be regarded as limiting. All compounds or components which can be used in the compositions are either known and commercially available or can be synthesised by known methods. The temperatures indicated in the examples are always in ° C. It furthermore goes without saying that, both in the description and also in the examples, the added amounts of the components in the compositions always add up to a total of 100%. Percentage data given should always be regarded in the given context. However, they usually always relate to the weight of the part-amount or total amount indicated.

Even without further comments, it is assumed that a person skilled in the art will be able to utilise the above description in its broadest scope. The preferred embodiments should therefore merely be regarded as descriptive disclosure which is absolutely not limiting in any way. The complete disclosure content of all applications and publications mentioned above and below is incorporated into this application by way of reference. The following examples are intended to illustrate the present invention. However, they should in no way be regarded as limiting. All compounds or components which can be used in the compositions are either known and commercially available or can be synthesised by known methods.

### EXAMPLES

### Example 1

### Preparation of SrLu_{1.98}Ce_{0.02}SiAl₄O₁₂ Via Hydrogencarbonate Precipitation

227 ml of ethanol, 85 ml of deionised water and 34 ml of tetraethyl orthosilicate are initially introduced, and 53 ml of ammonia solution (25%) are added over the course of 30 s. The mixture is stirred at pH 11.9 for a further 30 min., giving a milky suspension.

A pH of 7 is established over the course of 5 min. by addition of 60.1 g of hydrochloric acid (25%). 537.6 g of ammonium hydrogencarbonate are dissolved in 3000 ml of deionised water with warming and added to the SiO₂ suspension.

129.8 g of lutetium chloride hexahydrate, 2.53 g of cerium chloride heptahydrate, 164.2 g of aluminium chloride hexahydrate and 45.3 g of strontium chloride hexahydrate are dissolved in 600 ml of deionised water. The resultant solution is added dropwise to the hydrogencarbonate/SiO₂ suspension over the course of 45 min., and the mixture is stirred for a further 30 min. The solid is filtered off with suction and dried at 120° C. in a drying cabinet.

The resultant precursor is pre-calcined for 4 hours at 1100° C. under the laboratory atmosphere.

Yield: 125 g of pale-yellow powder.

The pre-calcined precursor is HT-calcined for 4 h at 1400° C. under 80% Ar/20% H₂. After cooling, the phosphor is ground and classified via a 20μ sieve.

### Example 2

### Preparation of SrLu_{1.98}Ce_{0.02}SiAl₄O₁₂ Via a Solid-State Diffusion Reaction (Mix & Fire)

66.29 g of lutetium oxide, 1.17 g of cerium dioxide, 34.66 g of aluminium oxide, 25.09 g of strontium carbonate, 10.21 g of silicon dioxide and 10 g of ammonium chloride are weighed out into a PE bottle. The bottle is screwed shut, and the mixture is homogenised on a roller bench for 8 hours.

The resultant precursor is pre-calcined for 4 hours at 1100° C. under the laboratory atmosphere. The pre-calcined precursor is then calcined for 4 h at 1400° C. under 80% Ar/20% H₂. After cooling, the phosphor is ground and classified via a 20μ sieve.

### Preparation of Nitridic Phosphors for Mixtures

### Example 3A

### Preparation of Sr_{1.8}Si₅N_{7.6}O_{0.4}:Eu

13.96 g of Sr₃N₂, 0.996 g of EuN and 4.512 g of silicon dioxide are weighed out and mixed in a nitrogen-filled glovebox. The resultant mixture is introduced into a molybdenum crucible and transferred into a tubular furnace. The mixture is subsequently calcined for 8 hours at 1600° C. under a nitrogen/hydrogen atmosphere. After cooling, the crude phosphor is removed, briefly ground in a mortar and re-introduced into a molybdenum crucible, which is then transferred into a high-pressure oven, where the phosphor is re-calcined for 8 hours at 1600° C. under a nitrogen pressure of 65 bar. After cooling, the phosphor is removed and suspended in 100 ml of 1 molar hydrochloric acid. The resultant suspension is stirred for 3 hours, and the stirrer is subsequently switched off. After a few minutes, the supernatant is poured off, and the residue which remains is taken up again in deionised water, filtered off with suction, washed with deionised water until neutral and dried.

### Example 3B

### Preparation of Sr₂Si₅N_{7.666}O_{0.5}:Eu

17.84 g of Sr₃N₂, 2.655 g of EuN, 22.21 g of silicon nitride and 1.502 of silicon dioxide are weighed out and mixed in a nitrogen-filled glovebox. The resultant mixture is introduced into a molybdenum crucible and transferred into a tubular furnace. The mixture is subsequently calcined for 8 hours at 1600° C. under a nitrogen/hydrogen atmosphere. After cooling, the crude phosphor is removed, briefly ground in a mortar and re-introduced into a molybdenum crucible, which is then transferred into a high-pressure oven, where the phosphor is re-calcined for 8 hours at 1600° C. under a nitrogen pressure of 65 bar.

After cooling, the phosphor is removed and suspended in 100 ml of deionised water. The resultant suspension is stirred for 30 minutes, and the stirrer is subsequently switched off. After a few minutes, the supernatant is poured off, and the residue which remains is taken up again in deionised water, filtered off with suction, washed with deionised water until neutral and dried.

### Example 3C

### Preparation of the Phosphor Sr₂Si₅N₈:Eu

1.84 g of Sr₃N₂, 0.166 g of EuN and 2.33 g of silicon nitride are weighed out and mixed in a nitrogen-filled glovebox. The resultant mixture is introduced into a molybdenum crucible and transferred into a tubular furnace. The mixture is subsequently calcined for 8 hours at 1600° C. under a nitrogen/hydrogen atmosphere. After cooling, the crude phosphor is removed, briefly ground in a mortar and re-introduced into a molybdenum crucible, which is then transferred into a high-pressure oven, where the phosphor is re-calcined for 8 hours at 1600° C. under a nitrogen pressure of 65 bar. After cooling, the phosphor is removed and suspended in 100 ml of deionised water. The resultant suspension is stirred for 30 minutes, and the stirrer is subsequently switched off. After a few minutes, the supernatant is poured off, and the residue which remains is taken up again in deionised water, filtered off with suction, washed with deionised water until neutral and dried.

### Example 3D

### Preparation of the Phosphor (Sr,Ca)AlSiN₃:Eu

2.22 g of Sr₃N₂, 0.33 g of Ca₃N₂, 0.05 g of EuN, 1.23 g of AlN and 1.4 g of silicon nitride are weighed out and mixed in a nitrogen-filled glovebox. The resultant mixture is introduced into a boron nitride crucible and transferred into a hot isostatic press (HIP). A nitrogen pressure of 500 bar was established, the material was subsequently heated to 1700° C. and conditioned at this temperature for 4 hours, during which the pressure rose to 1740 bar. After cooling and ventilation, the material was removed and suspended in 100 ml of deionised water. The resultant suspension is stirred for 30 minutes, and the stirrer is subsequently switched off. After a few minutes, the supernatant is poured off, and the residue which remains is taken up again in deionised water, filtered off with suction, washed with deionised water until neutral and dried.

### 4. Preparation of Phosphor Mixtures

### Example 4.1

### SrLu_{1.98}Ce_{0.002}SiAl₄O₁₂ Nitride

10 g of the phosphor from Example 1 are mixed intimately with 1 g of the phosphor from Example 3C.

A mixture comprising the phosphors from Examples 1 and 3A or 1 and 3B or 1 and 3D is prepared analogously.

### Example 5

### Production of a Light-Emitting Diode

The phosphor mixture from Example 4.1 is mixed with a 2-component silicone (OE 6550 from Dow Corning) in a tumble mixer in such a way that equal amounts of the phosphor mixture are dispersed in the two components of the silicone; the total concentration of the phosphor mixture in the silicone is 8% by weight.

5 ml of each of the two phosphor-containing silicone components are mixed homogeneously with one another and transferred into a dispenser. Empty LED packages from OSA optoelectronics, Berlin, which contain a 100 μm² GaN chip are filled with the aid of the dispenser. The LEDs are then placed in a heat chamber in order to solidify the silicone over 1 h at 150° C.

| | Emission | CIE | TQ₅₀ | |
|---|---|---|---|---|
| | max. | 1931 | value | Light |
| Composition | at [nm] | x, y | [° C.] | intensity* |
| SrLu_{1.98}Ce_{0.02}SiAl₄O₁₂ | 545 | 0.387 | 341 | 1.03 |
| | | 0.560 | | |
| BaY_{1.98}Ce_{0.02}SiAl₄O₁₂ | 552 | 0.429 | 289 | 0.84 |
| | | 0.543 | | |
| SrY_{1.98}Ce_{0.02}SiAl₄O₁₂ | 549 | 0.430 | 257 | 0.90 |
| | | 0.544 | | |
| BaLu_{1.98}Ce_{0.02}SiAl₄O₁₂ | 536 | 0.361 | 302 | 0.86 |
| | | 0.567 | | |

*Light intensity values were determined from the emission spectra (see FIGS. 1 to 3)

Table 1 shows the optical properties of SrLu_{1.98}Ce_{0.02}SiAl₄O₁₂ compared with known phosphors in accordance with US 2004/0062699.

CIE x and CIE y stand for the coordinates in the standard CIE colour chart (here standard observer 1931), familiar to the person skilled in the art, by means of which the colour of a light source is described.

All the quantities mentioned above are calculated from emission spectra of the light source by methods familiar to the person skilled in the art.

The TQ₅₀ value is the temperature at which the emission spectrum of a phosphor or LED still has 50% of the intensity that it had at a temperature of 0° C.

### DESCRIPTION OF THE FIGURES

FIG. 1: shows a comparison of the emission spectra of the phosphor according to the invention (a) SrLu_{1.98}Ce_{0.02}SiAl₄O₁₂ (peak at 545 nm; standardised intensity 1.03) with phosphor (b) BaY_{1.98}Ce_{0.02}SiAl₄O₁₂ (peak at 552 nm; standardised intensity 0.83) in accordance with US 2004/0062699. (The emission measurement was in each case carried out on a layer of the phosphor of optically infinite thickness on excitation at 450 nm using an Edinburgh Instruments OC290 spectrometer at room temperature.)

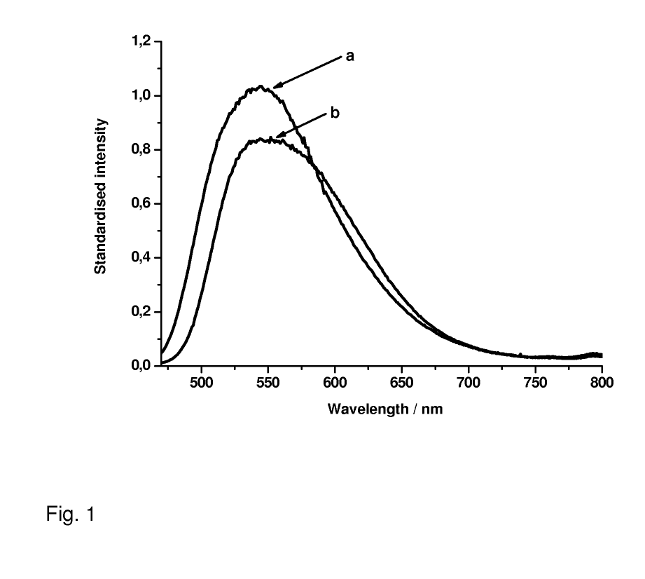

FIG. 2: shows a comparison of the emission spectra of the phosphor according to the invention (a) SrLu_{1.98}Ce_{0.02}SiAl₄O₁₂ (peak at 545 nm; standardised intensity 1.03) with phosphor (b) SrY_{1.98}Ce_{0.02}SiAl₄O₁₂ (peak at 549 nm; standardised intensity 0.90) in accordance with US 2004/0062699.

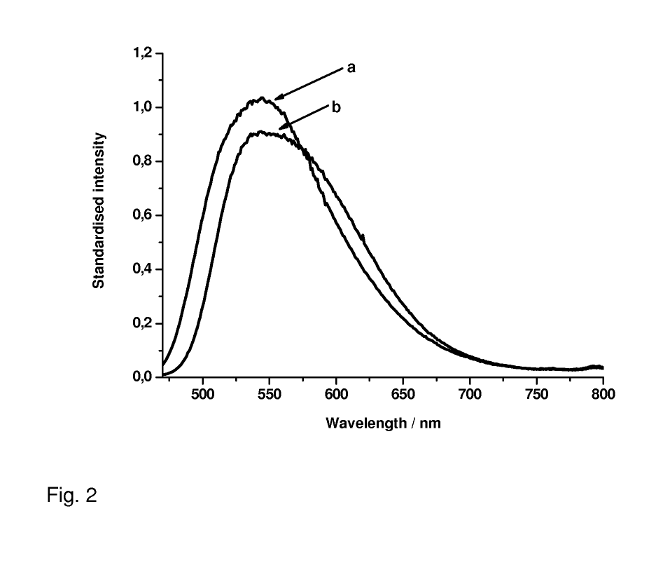

(The emission measurement was in each case carried out on a layer of the phosphor of optically infinite thickness on excitation at 450 nm using an Edinburgh Instruments OC290 spectrometer at room temperature.)

FIG. 3: shows a comparison of the emission spectra of the phosphor according to the invention (a) SrLu_{1.98}Ce_{0.02}SiAl₄O₁₂ (peak at 545 nm; standardised intensity 1.03) with phosphor (b) BaLu_{1.98}Ce_{0.02}SiAl₄O₁₂ (peak at 536 nm; standardised intensity 0.91) in accordance with US 2004/0062699. (The emission measurement was in each case carried out on a layer of the phosphor of optically infinite thickness on excitation at 450 nm using an Edinburgh Instruments OC290 spectrometer at room temperature.)

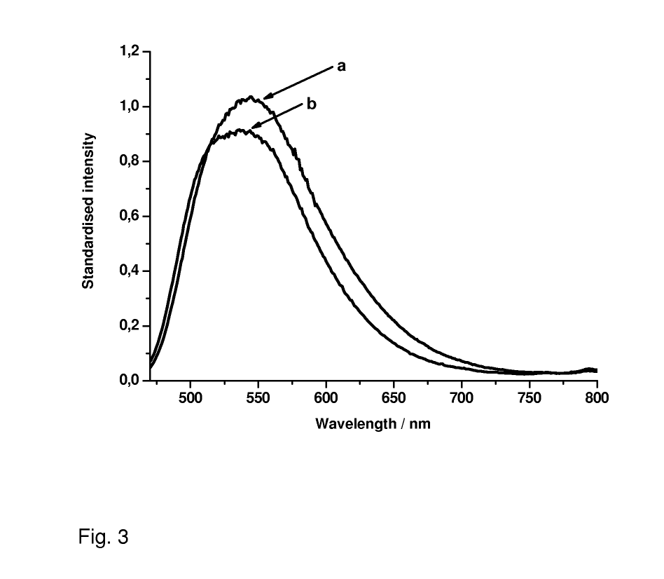

FIG. 4: shows a comparison of the temperature stability (TQ₅₀) of the emission spectra (excitation 450 nm) of the phosphor according to the invention (a) SrLu_{1.98}Ce_{0.02}SiAl₄O₁₂ with (b) SrY_{1.98}Ce_{0.02}SiAl₄O₁₂.

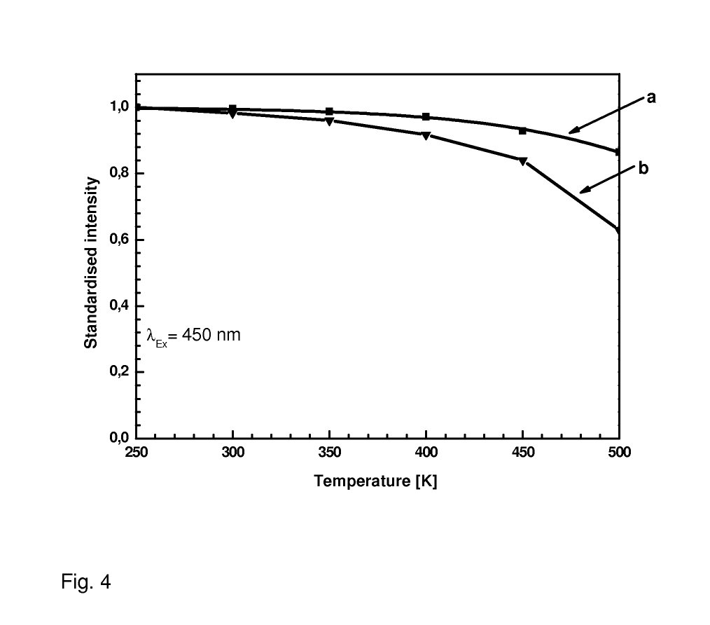

(The TQ measurement was carried out on an Edinburgh Instruments FLS920 with a Microstat N from Oxford Instruments. The excitation source used was an OSRAM 450Xe high-pressure discharge lamp, and the detector used was a Hamamatsu R2658P single photon multiplier. The measurement was carried out in 50K steps from 250 K to 500 K, stabilisation time 100 s.)

FIG. 5: shows a comparison of the temperature stability (TQ₅₀) of the emission spectra (excitation 450 nm) of the phosphor according to the invention (a) SrLu_{1.98}Ce_{0.02}SiAl₄O₁₂ with (b) BaY_{1.98}Ce_{0.02}SiAl₄O₁₂.

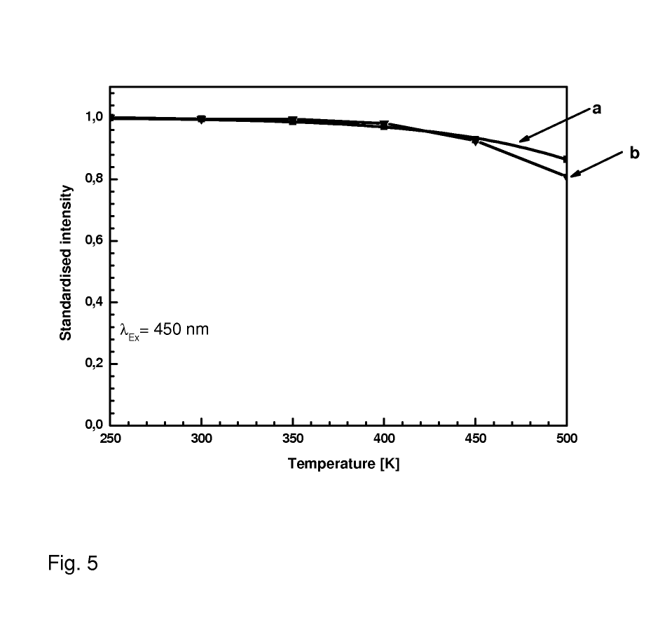

(The TQ measurement was carried out on an Edinburgh Instruments FLS920 with a Microstat N from Oxford Instruments. The excitation source used was an OSRAM 450Xe high-pressure discharge lamp, and the detector used was a Hamamatsu R2658P single photon multiplier. The measurement was carried out in 50 K steps from 250 K to 500 K, stabilisation time 100 s.)

1. Compound of the formula I
SrLu₂₋ₓSiAl₄O₁₂:Cex (I)
where
x stands for a value from the range from 0.01 to 0.15.

2. Compound according to claim 1, characterised in that x stands for a value from the range from 0.015 to 0.12, preferably from the range from 0.016 to 0.10.

3. Process for the preparation of a compound according to claim 1, comprising the following process steps:
a) mixing of lutetium-, cerium-, aluminium-, strontium- and silicon-containing materials,
b) addition of at least one further inorganic and/or organic substance,
c) thermal aftertreatment of the cerium-activated compound.

4. Process according to claim 3, characterised in that the compounds are prepared by wet-chemical methods from inorganic and/or organic metal and/or rare-earth salts by means of sol-gel methods, precipitation methods and/or drying methods, preferably spray drying.

5. Process according to claim 3, characterised in that the inorganic or organic substances (process step b) are selected from the group of the ammonium halides, alkaline-earth metal fluorides, such as calcium fluoride, strontium fluoride or barium fluoride, borates, boric acid, carbonates, preferably ammonium hydrogencarbonate, alcoholates, such as oxalates, and/or silicic acid esters, such as TEOS.

6. Mixture comprising at least one compound of the formula I according to claim 1 and at least one red-emitting phosphor.

7. Mixture according to claim 6, characterised in that said at least one red-emitting phosphor is selected from Ce-doped garnets, Eu-doped thiogallates, Eu-doped sulfoselenides and Eu- and/or Ce-doped nitrides, oxynitrides, alumonitrides and/or Mn(IV)-doped oxides and/or fluorides.

8. Mixture according to claim 7, characterised in that said at least one red-emitting phosphor is selected from nitridic phosphors, preferably (Ca,Sr,Ba)₂Si₅N₈:Eu, (Ca,Sr)AlSiN₃:Eu, (Ca,Sr,Ba)SiN₂:Eu, (Ca,Sr,Ba)₆Si₃O₆N₄:Eu or (Ca,Sr,Ba)_{2-x/2}Si₅N₈₋ₓOₓ:Eu, where x stands for a number from the range 0.01 to 3.

9. Process for the preparation of a mixture according to claim 6, characterised in that said at least one compound of the formula I is mixed with at least one red-emitting phosphor.

10. Light source, characterised in that it comprises a semiconductor and at least one phosphor of the formula I according to claim 1 and at least one red-emitting phosphor.

11. Light source according to claim 10, characterised in that the semiconductor is a luminescent indium aluminium gallium nitride, in particular of the formula InᵢGaⱼAlₖN, where 0≦i, 0≦j, 0≦k, and i+j+k=1.

12. Lighting unit, in particular for the backlighting of display devices, characterised in that it comprises at least one light source according to claim 10.

13. Lighting unit according to claim 12, characterised in that the optical coupling between the phosphor and the light source is achieved by a light-conducting arrangement.

14. Display device, in particular liquid-crystal display device (LC display), having backlighting, characterised in that it comprises at least one lighting unit according to claim 12.

15. A method for the partial or complete conversion of the blue or near-UV emission from a luminescent diode comprising using a compound according to claim 1 as a conversion phosphor for performing said partial or complete conversion.
